(19) United States
(12) Patent Application Publication
(10) Pub. No.: US 2026/0026994 A1
(43) Pub. Date: Jan. 29, 2026

(54) DEVICE FOR STRETCHING THE BACK

(71) Applicant: HIMTEC AG, Seengen (CH)

(72) Inventor: Marcel HÄNE, Seengen (CH)

(21) Appl. No.: 19/139,329

(22) PCT Filed: Dec. 6, 2023
(86) PCT No.: PCT/EP2023/084441

§ 371 Date: Jun. 13, 2025

(30) Foreign Application Priority Data
Dec. 14, 2022 (CH) CH001500/2022

(51) Int. Cl. A61H 1/02; A61G 13/00

(52) U.S. Cl. CPC A61H 1/0292; A61G 13/009; A61H 2201/1284; A61H 2201/164; A61H 2201/1676; A61H 2203/0456; A61H 2203/0468

(57) ABSTRACT

An example device includes a frame with opposing pendulum supports connected to a transverse support profile and on which a two-part frame with a front-frame part and rear-frame part is mounted for support. The front-frame part is attached to a slide guided in a longitudinally displaceable manner on a guide profile that projects vertically forward from the support profile. This carriage carries guide rollers, which can be moved into stationary guide profiles attached to the frame. These guide rollers are retracted into the guide profiles by pivoting the two-frame parts forward. They are guided in the same, so that when the frame parts and the two-part couch are pivoted, the relative distance between the first front-couch part and the rear-frame part and rear-couch part lying thereon can be varied and a person lying on the two-part couch can stretch.

### TECHNICAL FIELD

The invention relates to a device for independently stretching one's own back. Many people suffer from back pain and stretching their back on a stretching bed brings them relief. However, conventional stretching beds are not user-friendly enough and often cannot be operated alone, so that a person to be treated cannot effectively use the stretching bed alone, but requires a therapist or an assistant.

### BACKGROUND

WO 2015/107458 A1 discloses a stretching apparatus for stretching the back. This stretching apparatus consists of a base plate with a height-adjustable mast on which a couch is mounted at the upper end. The stretcher is mounted on this height-adjustable mast so that it can pivot about a horizontal axis. Adjustable restraining means for the upper arms near the armpits are mounted on a movable carriage with a cushion on the head side of the stretcher, and the restraining means with a foot cushion for the feet are mounted on a movable carriage with a cushion on the foot side of the stretcher. At the foot end of the stretcher, a standing surface is formed at right angles to the stretcher. Two handlebars for the manually controlled tilting of the stretcher are hinged to the front of the upper part of the mast. The movable carriages with the cushions, together with the restraining means on the stretcher, are connected to each other by means of cable pulls with a steel cable around several deflection pulleys in such a way that the carriages with the cushions can be moved apart in a coupled manner when the stretcher is swiveled around the horizontal position and, conversely, can be moved towards each other again. The back can be alternately stretched and relieved again by rocking the couch around its horizontal position. Although this construction works perfectly, it proves to be relatively complex and complicated with its various cable pulls and pulleys, heavy, bulky and, above all, expensive to manufacture. In addition, it can only be used upside down. US 10 695 254 B2 (EXPECTATIONS LLC [US]) shows a lounger hinged to a frame for lying on. Due to the shape of the stretcher as shown in FIG. 11, for example, it can be seen that it is intended for a person to lie on it in a supine position. A cushion is shown as a head rest in FIG. 8 at 205. It is clear that this is intended for the back of the head and certainly not for the face. This couch can be tilted so far above the horizontal with the person lying on it on their back that the head is then at the bottom and the feet at the top, i.e. the body is in an inverted position, held by the foot support. This inverted position stretches the body and especially the back.

In view of this state of the art, it is the task of the present invention to provide a device which is used for stretching the back in the supine or prone position of the user, and which is simpler, lighter, more space-saving and less complex in design, so that it can also be manufactured more cost-effectively, and which in particular does not require cable pulls, cable pulleys and deflection pulleys, and which furthermore can be used extremely easily and comfortably both prone and in the supine position, as well as being variably adjustable for different body positions, and by means of which the stretching of the back can be achieved, pulleys and pulleys, and which is furthermore extremely simple and comfortable to use both prone and supine, as well as being variably adjustable for different body sizes, and by means of which the stretching of the back can be very finely dosed by the user himself during use.

The problem is solved by a device for lying on one's stomach or in a supine position and for stretching the back, consisting of a frame with two opposing pendulum supports, the lower ends of which are connected to a cross-member profile, and on which cross-member profile a two-part frame consisting of a front frame part and a rear frame part is mounted for supporting a two-part couch, the rear frame part being attached to the cross-member profile in a rearwardly projecting manner and carrying foot rests at its rear end, and which is characterized in that a mechanical guide and mechanical ropeless coupling is provided between the pendulum supports and the two-part frame, by means of which, with a pendulum movement of the two-part frame, the front frame part can be pushed apart and pushed together again relative to the rear frame part and the parts of the two-part couch supported by them, for the controlled stretching of the upper body of a person lying on the two-part couch, in that this pendulum movement can be effected by the person himself. In this case, the person lies with their back or stomach on the couch, and the stretching of the back is not caused by an inverse position of the body but by moving the front part of the couch against the rear part of the couch, i.e. by moving it apart, and this is achieved by tilting and pivoting the couch on the frame. By pivoting back, the two parts of the stretcher are moved back towards each other, whereas in the prior art the two parts of the stretcher can be moved, but only to towards each other lock and secure them. in a suitable relative position to each other depending on the height of the user. It is therefore only a matter of adapting the table to the user's height. In operation, however, when someone is lying on the couch, the two parts are definitely not displaced relative to each other, and certainly not a function of the inclination actively moved apart as in order to stretch the back, and moved together again when pivoting back, in order to relieve the load, which is precisely the special feature of the device according to this application and by pivoting the couch.

### BRIEF DESCRIPTION OF THE FIGURES

This device and its individual parts are shown in the drawings and described below, whereby the function of the device is also explained and explained.

It shows:

FIG. 1: The appliance in the unfolded and upright position of use, viewed from the side;

FIG. 2: This appliance seen from the rear, i.e. from the right in relation to FIG. 1;

FIG. 3: This device seen from above;

FIG. 4: A perspective view of the middle section of this appliance, seen from the front and from the left-hand side towards the rear at an angle;

FIG. 5: A tube connected to the carriage on the rear frame section for the extendable guide rollers, with the guide roller retracted;

FIG. 6: This tube according to FIG. 5 for the extendable guide roller, with the guide roller extended;

FIG. 7: The middle section of the appliance seen from the left-hand side, with horizontal frame sections;

FIG. 8: This middle section of the appliance shown in FIG. 7, seen from the left-hand side, with the frame sections swung forward beyond the horizontal, or in this case counter-clockwise.

### DETAILED DESCRIPTION

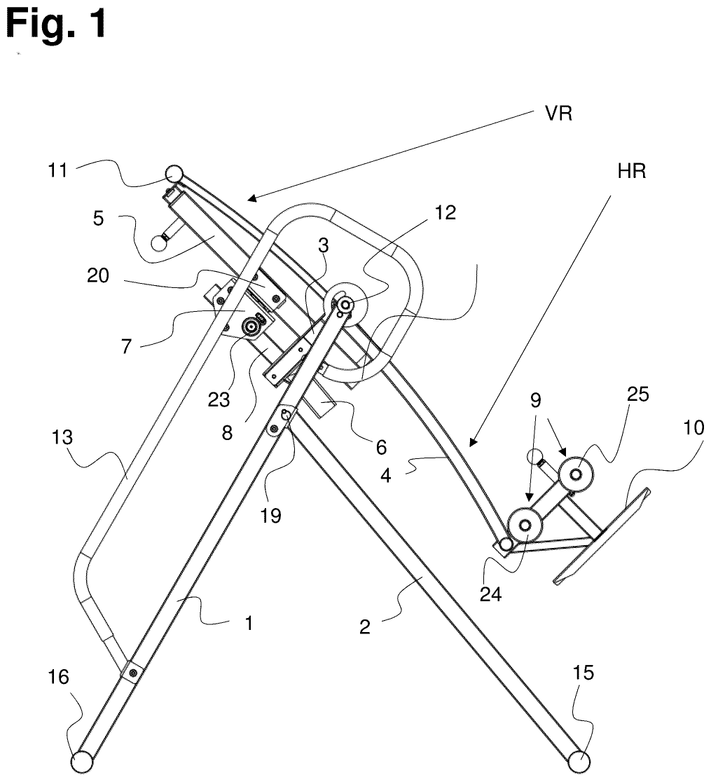

FIG. 1 shows the device in the unfolded and erected position of use, viewed from the left side, for lying on it prone or supine. The device consists of a frame 1, 2 with two opposing pendulum supports 3 on which a two-part frame with a front frame part VR and a rear frame part HR with the frame profiles 4, 5 for supporting a two-part couch is suspended. At the front part VR of the frame and below it, the frame profile 5 is firmly connected to this front part VR of the frame, while the frame in the rear part HR is formed by two frame profiles 4 running parallel to each other, whereby only one of these two frame profiles 4 can be seen in the side view shown here. The rear reclining part consisting of a board padded at the top can be mounted on these two parallel frame profiles 4. In the front part VR of the frame, this is supported by frame profile 5, on which the front part VR of the frame is mounted and is firmly connected to this frame profile 5. The frame profile 5 runs through a mount 20, in which it is firmly anchored. And this mount 20, for its part, sits on a slide 7, through which a guide profile 8 is guided, so that the slide 7 can be moved forwards and backwards on the slide 7, whereby this guide profile 8 protrudes at a right angle from a cross-member profile 17, which firmly connects the two pendulum beams 3 to each other. Ultimately, the frame profile 5 can thus be displaced a little forwards or backwards relative to the guide profile 8 on the same, and accordingly also the entire front frame part VR, and this front frame part VR can also be pivoted a little to the left and right about a vertical axis on the carriage 7. The frame for this entire construction is formed here by four supports 1, 2 in the manner of a trestle ladder, whereby a longer support 1 forms a pivot bearing 12 at its upper end for a pendulum beam 3 hanging downwards. The lower ends of the supports 1, 2 are connected to the supports 1, 2 on the other side of the appliance via connecting tubes 15, 16 to improve support on the ground. The slightly shorter support 2 is hinged to support 1 by approximately a quarter of the length of support 1 from the top, where it forms a folding hinge 19. This allows the frame to be folded up like a trestle ladder and can therefore be stored in a space-saving manner. The actual couch is not shown here and consists of two parts, a rear flat couch part for the pelvis and legs, which is mounted on the two frame profiles 4 of the rear frame part HR, seen here from the side, and a front flat couch part for the chest or back, which is attached to the front frame part VR, the distance between which and the rear couch part can then be varied by sliding the frame profile 5 carrying it on the slide 7 on the slide profile 8. These two reclining parts can be provided with padding to promote comfortable lying on them, either lying backwards on these reclining parts or lying prone. Both usage variants are possible.

In FIG. 1, the frame parts VR, HR and the reclining parts to be mounted thereon extend as a recliner at an angle of approximately 45° to the floor. But to get into the device, the stretcher in FIG. 1 is swiveled further clockwise around the swivel axis 12 of the pendulum supports 3 until it is approximately vertical. From this initial position, the stretcher can then be swiveled into the horizontal position after entering the device, and swiveled further, which then causes the body lying on it to be stretched, as described below.

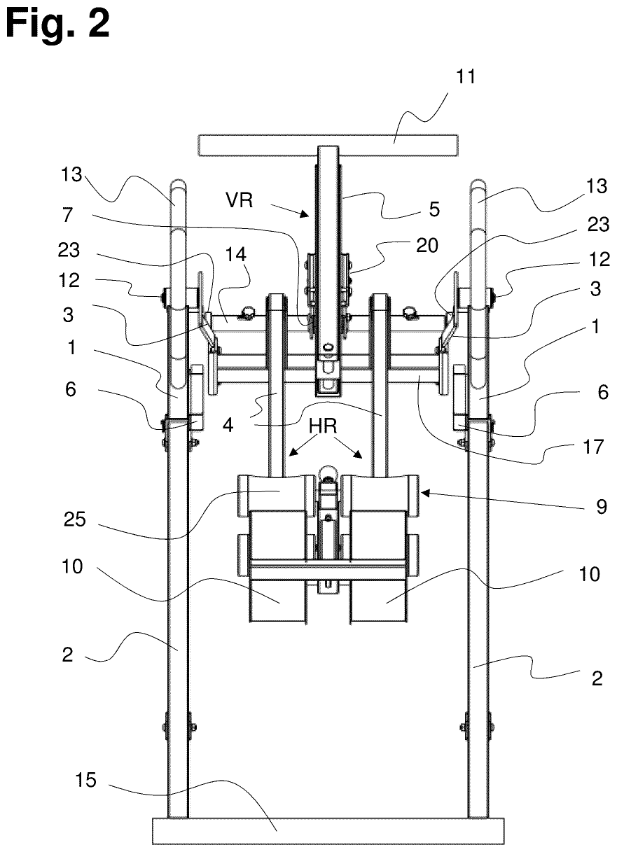

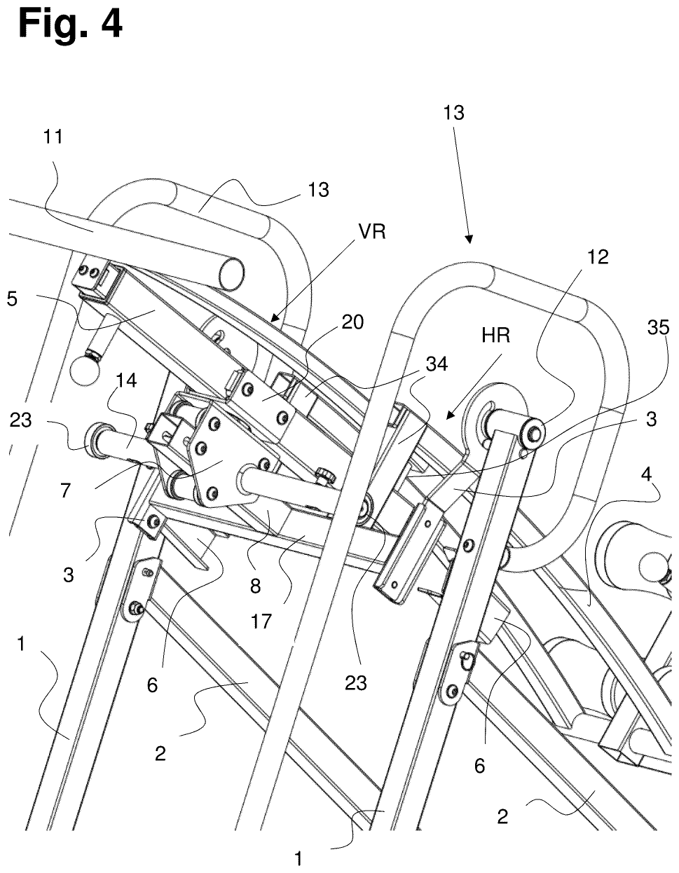

The two pendulum beams 3 are connected to each other at their lower ends between the two supports 1, 2 on each side via a cross-member profile 17 which is not visible here. The two rear frame profiles 4 of the rear frame part HR extend over this cross-member profile 17 and are firmly connected to it via two support profiles 34 standing vertically on this cross-member profile 17, as can be seen in FIG. 4. The rear frame part HR extends a little beyond this cross-member profile 17 at the front, as can be seen in FIG. 2. At the front end of the front frame part VR, a holding bar 11 is mounted running transversely to the couch, which can be gripped by the user with his hands when he climbs onto or into the device. A guide roller 23 can be seen on the side of the carriage 7 in FIG. 1. There is also a guide roller 23 on the other side of the carriage 7. A guide profile 6 can be seen protruding transversely from the support 1 at approximately the height of the lower end of the pendulum support 3. There is a similar guide profile 6 on the other side of the appliance. When the table is swiveled beyond the horizontal position, these guide rollers 23 enter the inner sides of these two guide profiles 6 and are guided in them. This causes the carriage 7 to be forcibly displaced forward on the guide profile 8 due to the geometry of the parts, and the carriage 7 is moved back on the guide profile 8 accordingly when it is swiveled back. This movement of the carriage 7 is naturally transferred to the front frame part VR mounted on it, which carries the front lying part not shown here. Overall, therefore, the distance between the front and rear reclining sections is varied, which causes the user's back to be stretched forwards according to the extent to which the recliner is swivelled beyond the horizontal and can be finely adjusted. Footrests 10 are attached to the lower end of the rear frame part HR, and slightly above them are restraining means 9, with two rollers 24, 25 for each leg. The distance between them can be adjusted to hold the feet above the ankles. From the area of the roller 24, the two rear frame profiles 4 extend slightly upwards as an arc up to the pendulum supports 3 and slightly beyond the cross support profile 17 and thus overlap the front frame profile 5, which extends forwards from the cross support profile 17 and runs in the middle of the device. The two rear frame profiles 4 are fitted with the rear, flat lying section, while the front frame section VR is fitted with a flat lying section for the upper body. Depending on the position of the user, whether they are lying prone or on their back on the bed, this front lying section supports the chest and abdominal area or the user's back. From the uppermost quarter of the support 1, a handle bar 13 first runs backwards, then upwards, where it bends and then runs downwards parallel to the support 1 at approximately the position of the carriage 7 and finally ends again on the support 1 itself in the lower area of the support 1 and is attached there. There is an identical handle bar 13 on the other side of the device. These handle bars 13 can be coated with a material that is easy to grip, for example with a sponge rubber or a suitable soft rubber.

When a user, starting from the approximately vertical position of the frame parts VR, HR, stands on the two footrests 10, facing the device, he can grasp the two handlebars 13 and initiate the pivoting of the couch and gradually grasp the handlebar 13 until he has assumed a horizontal position. From then on, he can take hold of the front support bar 11 and then continue to swivel the stretcher by shifting his weight, in FIG. 1 in an anticlockwise direction, which causes the front part of the stretcher to move away from the rear part and, when swiveled back, to move back together again. This rocking around the horizontal position allows the user to finely adjust the stretching force and the amount of stretching. The whole thing works in the same way if the user climbs onto the footrests 10 with their back against the device and then swivels more and more in the supine position into the horizontal position of the couch. Again, by holding on to the support bar 11 or the handlebars 13, the user can rock around the horizontal position of the lounger and thus achieve a finely dosed stretching of the upper body or their back, just as they feel comfortable and at ease.

In FIG. 2, this device is shown in a view seen from the rear, i.e. seen from the right with respect to FIG. 1. It can be seen here that the device has supports 1, 2 on both sides, i.e. left and right, of which only the shorter supports 2 can be seen here, and of the longer supports 1 only the uppermost section in each case. At the upper ends of the supports 1 on the other side here, there are pivot axles 12, on which a pendulum support 3 hanging downwards is pivotably mounted on the inside of each side of the appliance, so that it can pivot back and forth in a direction perpendicular to the plane of the drawing. The two pendulum supports 3 are connected to each other at their lower ends via a cross support profile 17. As can be seen, the two curved frame profiles 4 extend from the restraining means 9 for the feet slightly beyond the cross-member profile 17 and overlap the front frame profile 5 laterally to some extent. As can be seen, the lower ends of the two pendulum supports 3 are shifted slightly further towards the center of the appliance by two bends. Above the cross-member profile 17, a tube 14 leads away from the carriage 7 to the side on both sides and these tubes 14 are firmly connected to the carriage 7. They each carry a guide roller 23 at both ends. These guide rollers 23 are each located at the end of an inner tube that can be pulled out inside the tube 14. This allows them to be pulled out of the tube 14 and then take up a position further out than shown here. This is necessary in order to bring them into operative connection with the guide profiles 6, which are mounted here in the form of flat U-profiles on the supports 1 and project transversely from these, whereby these guide profiles 6 are directed with their open sides towards the center of the appliance. When the couch is swiveled, these guide rollers 23 move into these guide profiles 6 and are guided along these guide profiles 6 when the couch is swiveled further, which causes the carriage 7 to be forcibly displaced on the guide profile 8. The frame 20 and the front frame profile 5 clamped in it are then also moved with the carriage 7. It is moved forwards during rocking and, conversely, the carriage 7 is moved back on the guide profile 8 when it is swung back. However, because the front reclining part is mounted on this front frame part VR and front frame profile 5, which in turn sits on the carriage 7 with the mount 20, the two frame parts VR and HR are ultimately moved back and forth in relation to each other, i.e. the front frame part VR with its reclining part is varied in distance to the rear frame part HR and its reclining part. The retaining bar 11 can be seen at the front end of the front frame part VR and the foot supports 10 and the restraining means 9 for the feet can be seen at the lower end of the rear frame profiles 4. At the bottom you can see the connecting tube 15 for connecting the lower ends of the two supports 2.

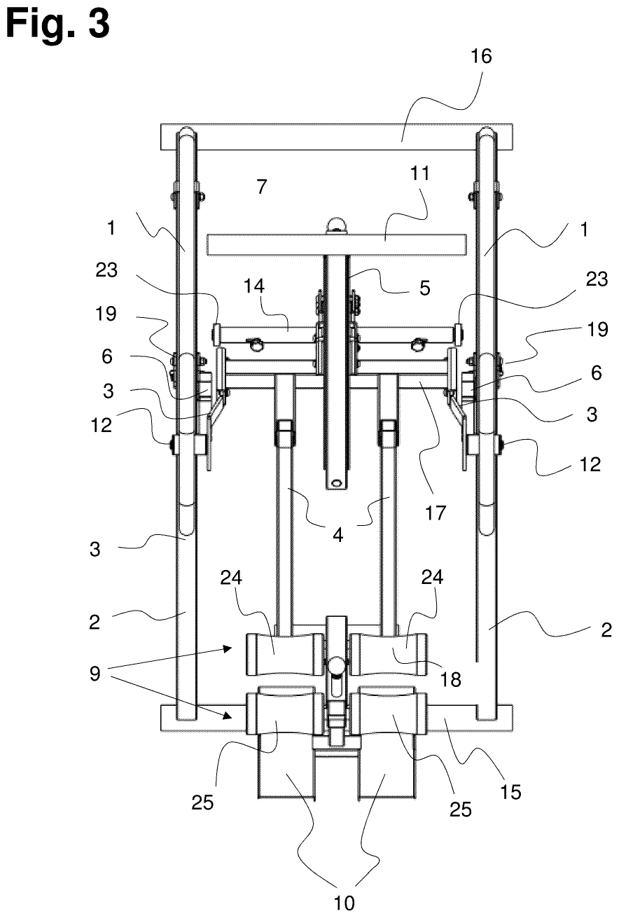

FIG. 3 shows the device as seen from above. Here you can see the supports 1 and 2 on each side of the device, which are connected to each other by hinges 19 and can be set up in the manner of a trestle ladder or can be folded around the hinges 19 when not in use. Also visible are the two pivot axles 12 at the upper end of the supports 1, on which the pendulum beams 3 hang. The ends of the pendulum beams 3 are slightly offset towards the center of the appliance and are firmly connected to a cross-member profile 17. The two tubes 14 with the end guide rollers 23 can also be seen above the cross-member profile 17, whereby these tubes 14 protrude laterally vertically from the carriage 7 and are firmly connected to it. As can be seen in FIG. 1, the front frame profile 5 is mounted on the carriage 7 with its socket 20, above which the front frame part VR is connected to it, and the retaining rod 11 extending transversely thereto is mounted at the front end of this front frame part VR. The two frame profiles 4, which form the rear frame part HR, on which the rear part of the lounger not shown is mounted, can be seen projecting forwards beyond the cross-member profile 17, pointing upwards in the picture. At the rear end of this rear frame part HR are the footrests 10 with their restraining means 9 for the feet, namely a pair of soft-elastic rollers 25 for the area above the heels of the person standing on the footrests 10, and a further pair of soft-elastic rollers 24 for nestling against the area at the front of the lower legs, above the ankles. This view from above also shows the two connecting tubes 15, 16 for connecting the lower ends of the supports 1 and 2 on both sides of the device.

FIG. 4 further illustrates the construction and shows the essential central part of this device in a perspective view from the front left and viewed at a slight angle to it. This view shows the uppermost sections of the supports 1 and the swivel axles 12 at their upper ends. These are realized here with bushes in which matching bolts are inserted, and the downwardly projecting pendulum beams 3 hang from the inner ends of these bolts on both sides of the device. These pendulum beams 3 have two kinks or bends so that their lower ends are offset towards the middle of the device. There, the pendulum supports 3 on both sides of the appliance are firmly connected to a cross support profile 17. As can be seen here, the front ends of the rear frame profiles 4 of the rear frame part HR are firmly connected to the support beams 34, which stand on the cross-member profile 17 and are therefore also fixed to the pendulum beams 3. The rear part of the front frame profile 5 extends backwards between the two support beams 34 and is held in the holder 20. In its rear area, this front frame profile 5 is firmly connected to the front frame part VR via the connecting profile 35 standing vertically on it, of which very little can be seen here. The frame 20 is pivotably mounted laterally at the top of the carriage 7, which has attached tubes 14 running perpendicular to them on its sides, each of which carries a guide roller 23 at its end. When the front frame part VR and rear frame part HR swivel around the swivel axis 12 of the pendulum profiles 3, these guide rollers 23 move into the guide profiles 6 on the inside and are then guided in the same. This forced guidance of the guide rollers 23 in the guide profiles 6 in conjunction with the geometry of their arrangement causes the front reclining part to move forwards on the front frame part VR when the frame parts VR, HR and the reclining parts mounted on them are pivoted forwards, in that the carriage 7 slides or rolls forwards on the guide profile 8, which is connected at right angles to the cross-member profile 17 at the rear, and thus also carries the frame 20 and thus the front frame profile 5, as well as the front frame part VR mounted on it and the reclining part mounted on it. In this way, the front lying part moves forwards in relation to the rear lying part and causes a person lying on these two lying parts to be stretched, regardless of whether they are lying on their stomach or back on this lying part. When swung back, the guide rollers 23 in the guide profiles 6 roll forwards again and cause the two lying sections to move towards each other. In this way, a person who first climbs onto the footrests 10 in the vertical position of the stretcher and then holds on to the handlebars 13 can slowly swing the stretcher forwards until the horizontal position is reached, and then, by gripping the transverse support bar 11, they can stretch themselves in a controlled manner by rocking their body more or less forwards and control the stretching force by the amount of rocking around the swivel axis 12. When the front lying section swivels back, it returns to its original distance from the rear lying section. The table can be swiveled back into the vertical position, in which it is easy to get off the device.

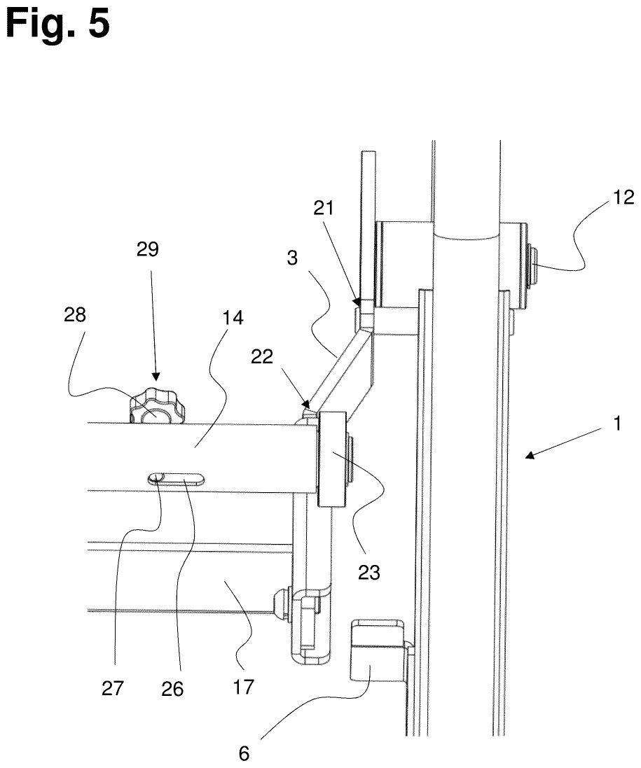

FIG. 5 shows the detail of a pendulum beam 3 as it is hinged at the top to the pivot axis 12 at the upper end of the support 1, and whose lower end is slightly offset towards the center of the device thanks to the two bending points 21, 22. At the lower end of the pendulum support 3 and firmly connected to it is the cross support profile 17, here in the form of a square steel profile. Above the support profile 17, you can see the one tube 14 on the side wall of the carriage 7 with its end guide roller 23, which sits on an inner tube that can be pulled out of the tube 14. To prevent the inner tube from falling out of the tube 14, the tube 14 has an elongated hole 26 at the side, and the inner tube has a cam 27 there, so that the inner tube can only be moved back and forth with its cam 27 within the elongated hole 26. However, it can be secured in any position by means of a radial grub screw 28 with handwheel 29.

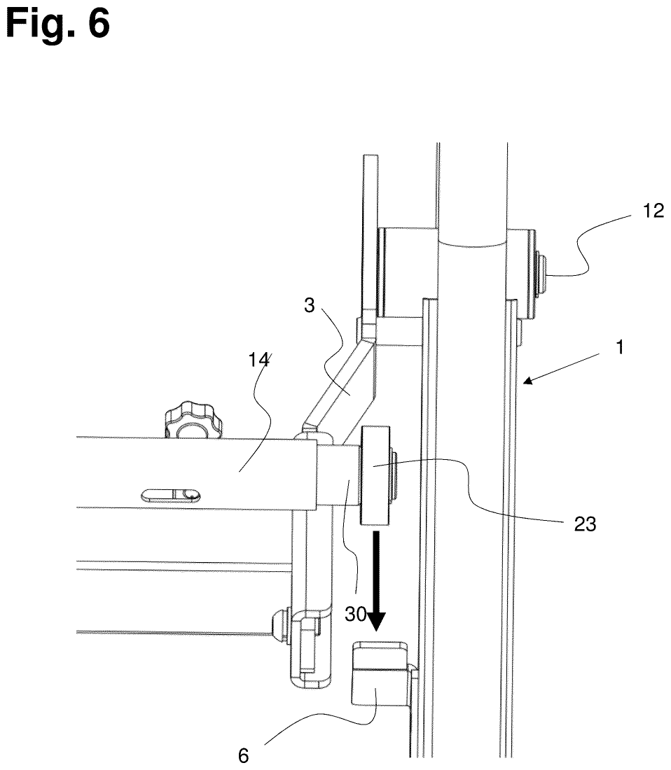

FIG. 6 shows the situation when the inner tube 30 is pulled out of the tube 14 with its end guide roller 23. In this position, it is retracted into the associated guide profile 6 on the support 1 by pivoting the couch, as indicated by the arrow, and must then follow it by force. This causes a relative movement of the tube 14 and thus of the carriage 7 on the guide profile 8, which is connected to the cross-member profile 17. The tube 14 is attached to the carriage 7 on both sides and projects orthogonally away from it. The carriage 7 together with the front frame profile 5 and front frame part VR therefore moves forwards and backwards on the guide profile 8 in accordance with the forward pivoting of the couch. The distance between the front reclining part on the front frame part VR on the one hand and the rear reclining part on the rear frame part HR with its two rear frame profiles 4 on the other hand can therefore be varied in a controlled manner.

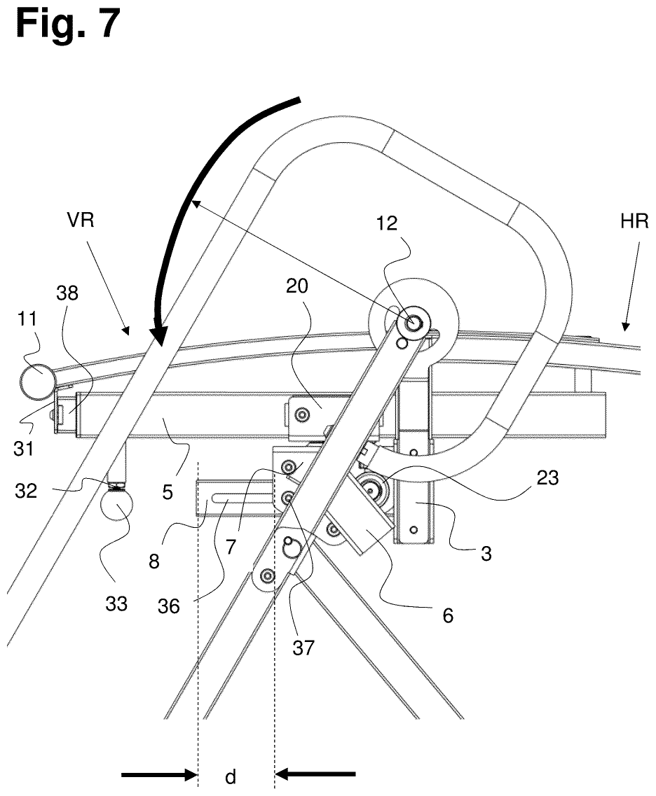

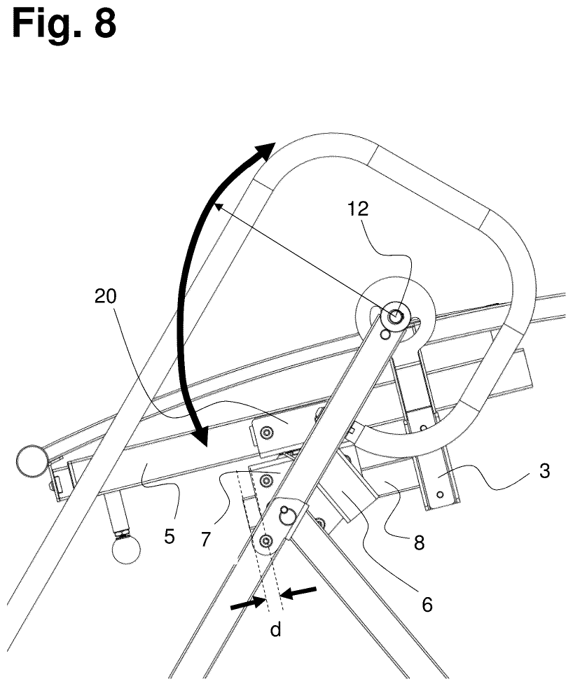

How the whole construction ultimately works can be seen in FIGS. 7 and 8, which show the central section around the swivel axes 12 of the device as seen from the side. First of all, FIG. 7 shows the situation when the couch has already been swiveled into the horizontal position. The distance d between the front end of the guide profile 8 and the slide 7 that can be moved on it is relatively large here. As can be seen, the guide profile 8 has an elongated hole 36 through which a transverse bolt 18 on the carriage 7 leads to its guide on the guide profile 8. The front frame part VR is mounted above the front frame profile 5 and stationary to it and the front frame profile 5 sits on the carriage 7 with its mount 20 pivotable sideways. This ensures that a person lying on the stretcher can swing their upper body out to the left and right about the vertical axis on the carriage 7 by holding on to the handle bar 11 in relation to the legs. So that the position of the handle bar 11 can be adjusted for more or less tall persons, it is connected at the front with the angle steel 31 to the front frame profile 5, i.e. to the front end of an inner profile 38, which can be pulled out forwards from the frame profile 5 and can be locked in several pull-out positions with the spring-loaded cross pin 32 with the grip ball 33 at its end inside the frame part 5. This allows the device and its recliner to be adapted to different body sizes of users, so that anyone can grasp the support bar 11 with outstretched arms when lying on it.

If the inner tubes 30 in the tube 14 are not extended, the guide rollers 23 do not engage in the guide profiles 6. In this case, the couch can be swiveled about the swivel axis 12 of the pendulum supports 3 as desired. The distance between the front and rear sections of the stretcher then always remains unchanged. However, if the inner tubes 30 are extended and locked in the extended position with the grub screws 28 and their handwheels 29, the following happens when the stretcher is swiveled counterclockwise in the direction shown in FIG. 8: The guide rollers 23 move into the guide profiles 6 and as they continue to swivel, they are forcibly guided along the inside of these guide profiles 6. This results in a relative movement of the carriage 7, to which the guide rollers 23 are connected via the tubes 14 projecting from it on both sides, to the stationary rear frame part 4. As a result, the carriage 7 is displaced forwards on the guide profile 8, and correspondingly also the front frame profile 5 carried by it and the front frame part VR mounted on it with the reclining part mounted on it, which is not shown. The bolts 18 on the carriage 7, which engage in the slotted hole 36 on the guide profile 8, move therein from the position shown in FIG. 7 to the position shown in FIG. 8. There, the carriage 7 has moved almost to the front end of the guide profile 8. Accordingly, the distance d from the rear frame part HR to the front frame part VR is increased, as shown by the distance arrows in FIGS. 7 and 8. The two separate parts of the couch, which are mounted on the frame parts VR and HR, also move. The front part therefore moves away from the rear part of the recliner. And when the recliner is swung back again, the distance d decreases again. This means that by rocking the lounger back and forth, the user can fine-tune the extension of their upper body themselves, regardless of whether they are lying on their stomach or on their back.

### LIST OF DIGITS

VR Front frame section to accommodate the sliding front section of the lounger
HR Rear frame section for holding the rear section of the lounger
1 Longer supports 1 on the frame
2 Shorter supports 2 on the frame
3 Pendulum beam
4 Rear frame profiles
5 Front frame profile, held in frame 20
6 Guide profiles for the guide wheels
7 Sledge
8 Guide profile, projecting vertically forwards on the cross-member profile and thus connected to the pendulum supports 3
9 Retaining agent
10 Foot rests
11 Crossbar, holding bar
12 Swivel axis for the pendulum beams 3
13 Retaining bracket
14 Tube with guide rollers that can be extended at the end 23
15 Connecting tube at the bottom between the two supports 2
16 Connecting pipe at the bottom between the two § s 1
17 Cross-member profile between the lower ends of the two pendulum beams 3
18 Bolt through slide 7, goes through slot 36
19 Folding axis of the frame, between uprights 1 and 2
20 Socket for the front frame profile 5
21 First bend on the pendulum beam 3
22 Second bend on the pendulum beam 3
23 Guide rollers on the outside of the tubes 14 projecting laterally from the carriage 7
24 Front role of the retention means
25 Rear role of the retaining means
26 Oblong hole in the tube 14 for the displacement of the inner tube 30 in its interior, which carries the end guide rollers 23 on the outside
27 Cam on the inner tube 30, which protrudes into the slotted hole 26
28 Grub screw for locking the inner tube 30 in the tube 14
29 Handwheel for grub screw
30 Inner tube with the end roller 23
31 Inner profile for the retaining bar 11
32 Spring-loaded locking pin
33 Grip ball for locking pin
34 Support profiles on the cross-member profile 17
35 Connecting profiles connected vertically to frame profile 5 with VR
36 Slotted hole in guide profile 8

1. Apparatus for lying on the abdomen or in a supine position and for stretching the back, consisting of:
a frame with two opposing pendulum supports, having lower ends of which are connected to a transverse support profile, and on which a cross-member profile is mounted a two-part frame comprising a front frame part and a rear frame part for supporting a two-part couch, the rear frame part being mounted on the cross-member profile so as to project rearwardly and carrying foot rests at its rear end, characterized in that a mechanical guide and mechanical ropeless coupling is provided between the pendulum supports and the two-part frame, by means of which, with a pendulum movement of the two-part frame, the front frame part can be pushed apart and pushed together again relative to the rear frame part and parts of the two-part couch supported by them, for the metered stretching of an upper body of a person lying on the two-part couch, in that this pendulum movement can be effected by the person.

2. The apparatus according to claim 1, characterized in that the mechanical guidance and mechanical ropeless coupling is designed such that the front frame part with the front lying part carried by it is connected to a carriage which is displaceably guided on a guide profile which is mounted projecting forwards on the cross-member profile, the carriage carrying lateral guide rollers, which, when the two frame parts are pivoted forwards, move into stationary guide profiles on the frame and are positively guided therein, so that when the two frame parts are pivoted forwards, the front frame part can be moved relatively forwards away from the pivoting rear frame part and, when the two frame parts are pivoted backwards, can be moved back into the initial state.

3. The apparatus according to claim 1, characterized in that the mechanical guidance and mechanical ropeless coupling is designed in such a way that the two frame parts and the two lying parts supported by them can be pivoted with the pendulum supports about their pivot axis from a vertical into a horizontal position and beyond, and in that a mount is arranged on the carriage, which mount can be pivoted laterally thereon and in which a front frame profile is fastened, which carries the front frame part, and in that the stationary guide profiles are attached to the longer frame supports and extend obliquely downwards, and in that the guide rollers are fastened to the outer ends of two tubes projecting laterally away from the carriage, so that the guide rollers can be retracted into these guide profiles by pivoting the two frame parts forwards and are then forcibly guided therein, so that when the frame parts and the two-part couch supported by them, the relative distance between the first front couch part on the front frame part and rear frame part and the rear couch part lying thereon can be changed in a positively controlled manner by displacement of the carriage on the guide profile by the guide rollers in the guide profiles and thus stretching of a person lying on the two-part couch from the same can be effected.

4. The apparatus according to claim 1, characterized in that the mechanical guidance and ropeless mechanical coupling is designed in such a way that the frame can be folded about a folding axis and has two supports on both sides and two shorter supports hinged thereto in the manner of a trestle ladder, and the pendulum supports are articulated in the upper region of the longer supports so as to be suspended in a pendulum manner about a pivot axis, and in that they hang downwards within the frame, each via two bends and their lower ends are firmly connected to a cross-member profile extending parallel to the folding axis of the frame, and the rear frame profiles for the rear frame part and the reclining part to be fastened thereon are fastened to this cross-member profile, the rear frame part carrying two foot supports with retaining means at the lower, rear end, and the cross-member profile carrying the forwardly projecting guide profile, on which the carriage is displaceably mounted, this carriage having on both sides transversely projecting tubes with guide rollers at the ends, and in that the stationary guide profiles on the longer supports on the frame are each formed on both sides by a guide profile with a U-shaped cross-section which is open towards the center of the appliance and projects obliquely downwards from the support of the frame, and the guide rollers are mounted on the tubes at the end of inner tubes, which can be extended from the tubes in the axial direction and can be retracted into the guide profiles in the extended state, whereupon they move back and forth therein when the frame parts are pivoted about the horizontal position and forcibly displace the carriage on the profile together with the front frame part back and forth relative thereto, and furthermore that a transverse rod is attached to the front end of the front frame part as a retaining rod.

5. The apparatus according to claim 1, characterized in that the rear frame part carries two foot rests at its rear end and two mutually spaced-apart retaining means in the form of padded rollers are provided above each foot rest at the level of the ankles of a foot placed on the foot rest, in each case one of the rollers of the retaining means for each foot being displaceable towards opposite rollers and being securable in a clamping position, for retaining the foot rest are provided, wherein one of the rollers of the restraining means for each foot can be displaced towards opposite rollers and secured in a clamping position in order to hold the foot on the footrest.

6. The apparatus according to claim 1, characterized in that handlebars are attached to the frame on both sides of the frame, which handlebars can be grasped by the person in the vertical position of the couch for climbing onto the footrests at the rear lower end of the rear frame part and extend on the frame over an ergonomically adapted arc, so that the handlebar can be grasped by the hands over the entire swivel range of the couch, at the rear, lower end of the rear frame part and extend on the frame over an ergonomically adapted arc, so that the handle bar can be grasped by the person's hands over the entire swivel range of the couch, whereby the swivel position of the couch can be adjusted and controlled by the person.

7. The apparatus according to claim 1, characterized in that the rear frame part and the front frame part each carry a flat lying part with a padding on the upper side, so that these two longitudinal sections of the lying part can be varied in their distance from one another when the frame parts are pivoted about the pivot axis of the pendulum supports.

8. The apparatus according to claim 1, characterized in that the frame is a frame which can be folded about a folding axis in the manner of a trestle ladder, with longer supports on one side of the folding axis and shorter supports opposite the folding axis, the shorter supports running less steeply than the longer supports when the frame is unfolded and erected, to which the shorter supports are articulated with their ends in the upper region of one quarter below their upper end of the longer supports, so that the folding axis is formed there, while the pendulum supports are articulated in a pendulum manner, hanging downwards, to the pivot axles at the upper end of the longer supports.

9. The apparatus according to 8, characterized in that the lower ends of the two suspended pendulum beams are connected to a cross-member profile connecting them, and the two rear frame profiles are mounted transversely and centrally above this cross-member profile and resting on it, which form the rear frame part, and the cross-member profile carries the guide profile projecting forwards thereon, on which the carriage is guided longitudinally displaceably by means of bolts in slotted holes in this section of the guide profile, wherein the front frame profile is mounted on this carriage and extends forwards and an inner profile is longitudinally displaceably mounted therein, which is connected at the front end to the front frame part and the retaining bar, wherein the inner profile can be locked in several extension positions relative to the front frame profile by means of a spring-loaded pin with a grip ball, for adjusting the support bar to the height of the person using the device.

10. The apparatus according to claim 9, characterized in that the displaceable carriage is equipped on both sides with tubes projecting transversely from it with end guide rollers which are held at the outer ends by inner tubes, which can be extended in the axial direction from the tubes and can be locked in the extended state and which only in this state move into the guide profiles and are then guided therein, so that when the guide rollers are not extended, the pivoting of the couch about the pivot axis does not cause any variation in the distance between its front frame part and the rear frame part.

11. The apparatus according to claim 1, characterized in that the frame is a frame which can be folded about a folding axis and has two supports on both sides and two shorter supports hinged thereto in the manner of a trestle ladder, the lower ends of the two supports on the one hand and of the two supports on the other hand each being connected to a connecting tube for improved stabilization of the support and of the frame.
